(19) United States
(12) Patent Application Publication
(10) Pub. No.: US 2006/0194556 A1
(43) Pub. Date: Aug. 31, 2006

(54) Local oscillation circuit for direct conversion receiver

(75) Inventors: Yun-Seo Park, Atlanta, GA (US); Sang-Hyun Woo, Seoul (KR); Jong-Ae Park, Yongin-si (KR); Seong-Soo Lee, Suwon-si (KR); Chang-Ho Lee, Marietta, GA (US); Joy Laskar, Marietta, GA (US)

Correspondence Address: DILWORTH & BARRESE, LLP, 333 EARLE OVINGTON BLVD., UNIONDALE, NY, 11553, US

(73) Assignees: Samsung Electronics Co., Ltd., Suwon-si (KR); GEORGIA TECH RESEARCH CO., Atlanta, GA (US)

(21) Appl. No.: 11/345,738

(22) Filed: Feb. 2, 2006

Related U.S. Application Data
(60) Provisional application No. 60/649,222, filed on Feb. 2, 2005.

(30) Foreign Application Priority Data
Jan. 25, 2006 (KR) 2006-7971

(51) Int. Cl. H04B 1/06; H04B 1/26

(52) U.S. Cl. 455/255; 455/323

(57) ABSTRACT

Disclosed is a local oscillation circuit for a direct conversion receiver, which includes a local oscillator for outputting a local oscillation signal of a predetermined frequency; and a fractional signal generator for converting the local oscillation signal into a fractional harmonic signal, which has a frequency equal to a frequency of a received signal, and outputting the converted signal to a down converter. The fractional signal generator includes a divider for dividing a frequency of an output signal of the fractional signal generator by a predetermined integer; and a mixer for mixing the local oscillation signal and an output signal of the divider.

### PRIORITY

This application claims the benefit under 35 U.S.C. 119(a) to an application entitled “Local Oscillation Circuit For Direct Conversion Receiver” filed in the Korean Intellectual Property Office on Jan. 25, 2006 and assigned Serial No. 2006-7971, and an application entitled “Fractional Signal Generation For Direct Conversion Receiver” filed in the U.S. Patent & Trademark Office on Feb. 2, 2005 and assigned Provisional Patent Application Ser. No. 60/649,222, the entire contents of both of which are incorporated herein by reference.

### BACKGROUND OF THE INVENTION

1. Field of the Invention

The present invention relates to a direct conversion receiver (DCR), and more particularly to a local oscillation circuit for a DCR which can reduce the direct current offset by employing a fractional signal generator.

2. Description of the Related Art

With the increase in portable wireless communication devices combined with popularization of wireless communication, elements contained in a transmission/reception device tend to be integrated into a single chip in order to achieve miniaturization, lower power consumption, and lower price of the transmission/reception device.

A direct conversion receiver (DCR) down-converts a received signal into a baseband signal, without an interim conversion step to convert the received signal into an intermediate frequency (IF) signal, so that the DCR does not need circuit construction for an intermediate frequency, which enables the miniaturization of the transmission/reception device.

FIG. 1 is a block diagram schematically illustrating the construction of a conventional DCR. A signal received through an antenna 101 is amplified through a low-noise amplifier 103, is transmitted to a down converter 105, and then is mixed in the down converter with a local oscillation frequency signal output from a local oscillator. The output signal of the down converter 105 is transmitted to a low pass filter 107, which removes harmonics caused by the non-linear characteristics of the down converter and local oscillator. After this, the output signal of the low pass filter 107 is transmitted through an amplifier 109 to a demodulator.

The DCR as described above has an advantage in that it can be manufactured in a small size, but has a disadvantage in that signal interference may be caused by a direct current (DC) offset. In other words, since a local oscillation frequency signal generated by the local oscillator has the same frequency as a signal received through the antenna 101, a direct current offset is generated while mixing the received signal with the local oscillation frequency signal, and this direct current offset acts as interference to the received signal. The direct current offset may be generated by various elements included in the DCR, such as by the amplifier, the local oscillator, etc., but most of the direct current offset is caused by leakage current from the local oscillator to the front port of the low-noise amplifier 103 or the RF port of the down converter 105.

When the local oscillation frequency signal is “COS w_{LO}t”, the direct current offset becomes “½” based on Equation (1):

$$\begin{matrix}COS {w}_{LO} t \times COS {w}_{LO} t = {( COS {w}_{LO} t )}^{2} \\ = \frac{1 + COS 2 {w}_{LO} t}{2}\end{matrix} \qquad ( 1 )$$

Meanwhile, various schemes have been proposed in order to remove direct current offset which degrades the performance of the DCR.

FIG. 2 is a block diagram illustrating a local oscillation circuit employing a frequency divider. The local oscillation circuit includes a divider 203, which is disposed between a down converter 201 and a local oscillator 205, in order to remove direct current offset caused by a local oscillation frequency signal. In the local oscillation circuit employing the divider, it is assumed that a received signal has a frequency of 5 GHz, and the local oscillator 205 oscillates and outputs a local oscillation signal of 10 GHz to the divider 203. Then, the divider 203 divides the frequency of the local oscillation signal by two to obtain a signal of 5 GHz, and outputs the obtained signal of 5 GHz to the down converter 201. However, in this case, if the received signal includes a second harmonic, serious phase mismatch may occur between I/Q signals. In addition, it is very difficult to oscillate and divide a local oscillation signal of a high frequency, and also requires a high power consumption.

FIG. 3 is a block diagram illustrating a local oscillation circuit employing a frequency multiplier. The local oscillation circuit includes a multiplier 303, instead of a divider, which is disposed between a down converter 301 and a local oscillator 305. In the local oscillation circuit employing the multiplier, it is assumed that a received signal has a frequency of 5 GHz, and the local oscillator 305 oscillates and outputs a local oscillation signal of 2.5 GHz to the multiplier 303. Then, the multiplier 303 multiplies the frequency of the local oscillation signal by two to obtain a signal of 5 GHz, and outputs the obtained signal of 5 GHz to the down converter 301. The local oscillation circuit employing the multiplier has an advantage in that it can be easily realized. However, the local oscillation circuit employing the multiplier has phase noise that is too high to be applied to a portable device, and causes serious I/Q mismatch because a gain can be obtained only in a narrow band.

### SUMMARY OF THE INVENTION

Accordingly, the present invention has been made to solve the above-mentioned problems occurring in the prior art, and an object of the present invention is to provide a local oscillation circuit capable of reducing direct current offset by employing a newly-proposed fractional signal generator (FSG).

To accomplish this object, in accordance with one aspect of the present invention, there is provided a local oscillation circuit including: a local oscillator for outputting a local oscillation signal of a predetermined frequency; and a fractional signal generator for converting the local oscillation signal into a fractional harmonic signal, which has a frequency equal to a frequency of a received signal, and outputting the converted signal to a down converter. Preferably, the fractional signal generator includes a divider for dividing a frequency of an output signal of the fractional signal generator by a predetermined integer; and a mixer for mixing the local oscillation signal and an output signal of the divider.

In accordance with another aspect of the present invention, there is provided a method for local oscillation in a direct conversion receiver including a down converter, which mixes a received signal and a signal having a frequency equal to a frequency of the received signal so as to convert the received signal into a baseband signal, the method including outputting a local oscillation signal of a predetermined frequency; converting the local oscillation signal into a fractional harmonic signal having a frequency equal to a frequency of the received signal; and outputting the fractional harmonic signal to the down converter.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically illustrating a conventional DCR;

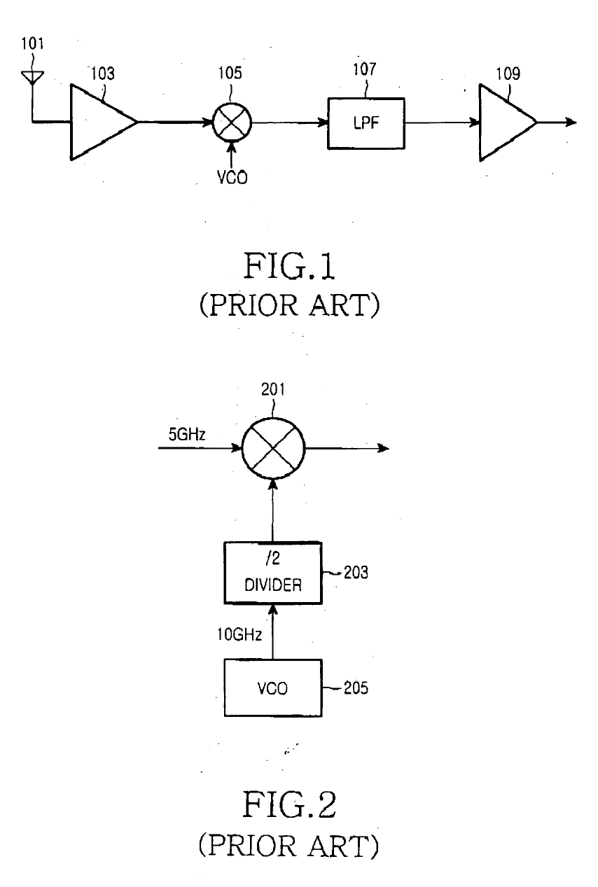

FIG. 2 is a block diagram illustrating a local oscillation circuit employing a divider; FIG. 3 is a block diagram illustrating a local oscillation circuit employing a multiplier;

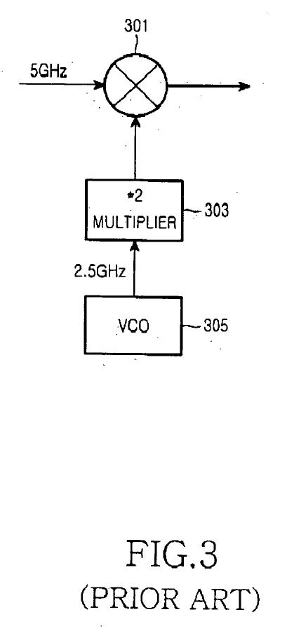

FIG. 4 is a block diagram illustrating a direct conversion receiver (DCR) according to an embodiment of the present invention; and

FIG. 5 is a block diagram illustrating the internal construction of the fractional signal generator shown in FIG. 4.

### DETAILED DESCRIPTION OF THE PREFERRED EMBODIMENT

Hereinafter, a preferred embodiment of a local oscillation circuit according to the present invention will be described with reference to the accompanying drawings. In the following description of the embodiments of the present invention, a detailed description of known functions and configurations incorporated herein will be omitted when it may obscure the subject matter of the present invention.

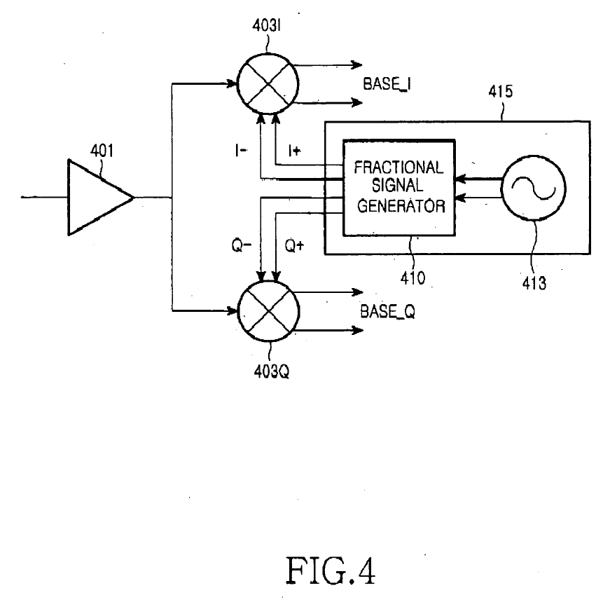

FIG. 4 is a block diagram illustrating a direct conversion receiver (DCR) according to the present invention. The DCR includes a low-noise amplifier 401 for amplifying a signal received through an antenna and outputting an I signal and a Q signal, a pair of down converters 4031 and 403Q for down-converting the I and Q signals, respectively, and a local oscillation circuit 415 for outputting oscillation frequencies to the down converters 4031 and 403Q.

The local oscillation circuit 415 includes a local oscillator 413 for generating a predetermined frequency signal, and a fractional signal generator 410. The fractional signal generator 410 processes an output signal of the local oscillator 413 to generate a local oscillation signal having the same frequency as an input signal, and outputs the generated local oscillation signal to the down converters.

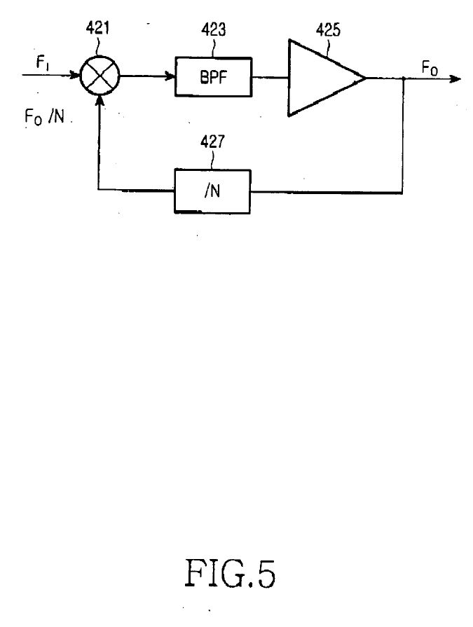

FIG. 5 is a block diagram illustrating the internal construction of the fractional signal generator shown in FIG. 4.

The fractional signal generator 410 includes a mixer 421 for outputting an oscillation signal of a desired frequency by mixing a medium frequency signal with an output signal of the local oscillator 413, and a divider 427 for generating the medium frequency signal by dividing the output signal of the mixer 421 by a predetermined integer “N”. In addition, the fractional signal generator 410 includes a band pass filter 423 for filtering the output signal of the mixer 421, and an amplifier 425 for amplifying a signal having passed through the band pass filter 423.

The operation of the fractional signal generator will now be described. A first medium frequency is called “F_{O}/N”. At a first stage, the first medium frequency “F_{O}/N” is multiplied a signal “F_{I}” by the mixer 421. At a second stage, the mixer 421 outputs signals “F_{I}+F_{O}/N” and “F_{I}−F_{O}/N”. Then, the band pass filer 423 filters the signals so as to pass any one harmonic component selected from “+” and “−” components.

The following description will be given with respect to a case in which the band pass filter 423 discards the signal “F_{I}+F_{O}/N” and passes only the signal “F_{I}−F_{O}/N”. Since the amplifier 425 functions to amplify only an input signal, “F_{I}−F_{O}/N” becomes “F_{O}”. Therefore, the output signal of the fractional signal generator may be expressed as Equation (2):
F_{I}−F_{O}/N=F_{O}
F_{I}=(1+1/N)F_{O}
F_{O}=NF_{I}/(1+N) (2)

Based on Equation (2), in the case in which a target frequency “F_{O}” is 5 GHz, if the value of “N” is set as “2”, a desired output frequency “F_{I}” of the local oscillator becomes 7.5 GHz.

Herein, the value of “N” is not limited to “2”, but may change depending on a target frequency and an output range of a used local oscillator.

If the band pass filter 423 filters signals so as to pass the “F_{I}+F_{O}/N” component, the output signal of the fractional signal generator may be expressed as Equation (3).
F_{O}=NF_{I}/(N−1) (3)

Based on Equation (3), in the case in which a target frequency “F_{O}” is 5 GHz, if the value of “N” is set as “2”, an output frequency “F_{I}” of the local oscillator becomes 2.5 GHz.

As described above, according to the local oscillation circuit of the present invention, a fractional signal generator is disposed between a down converter and a local oscillator outputting an oscillation frequency, thereby reducing direct current offset which causes degradation of the bit error rate (BER) of received signals. Also, the local oscillation circuit according to the present invention requires a relatively lower local oscillation frequency because it employs the fractional signal generator, instead of the conventional divider, so it is possible to use a local oscillator requiring a narrow tuning range.

In addition, the local oscillation circuit according to the present invention requires a local oscillator of a lower oscillation frequency than the conventional local oscillation circuit using a divider, so that the local oscillation circuit can be easily realized.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A local oscillation circuit comprising:
a local oscillator for outputting a local oscillation signal of a predetermined frequency; and
a fractional signal generator for converting the local oscillation signal into a fractional harmonic signal, which has a frequency equal to a frequency of a received signal, and outputting the converted signal to a down converter.

2. The local oscillation circuit as claimed in claim 1, wherein the fractional signal generator comprises:
a divider for dividing a frequency of an output signal of the fractional signal generator by a predetermined integer; and
a mixer for mixing the local oscillation signal and an output signal of the divider.

3. The local oscillation circuit as claimed in claim 2, wherein the fractional signal generator further comprises a band pass filter for filtering an output signal of the mixer.

4. The local oscillation circuit as claimed in claim 2, wherein the fractional signal generator further comprises an amplifier for amplifying the output signal of the mixer.

5. The local oscillation circuit as claimed in claim 2, wherein the fractional signal generator further comprises:
a band pass filter for filtering an output signal of the mixer; and
an amplifier for amplifying an output signal of the band pass filter.

6. The local oscillation circuit as claimed in claim 3, wherein the band pass filter filters a “+” or “−” harmonic component from the output signal of the mixer.

7. The local oscillation circuit as claimed in claim 5, wherein the band pass filter filters a “+” or “−” harmonic component from the output signal of the mixer.

8. A method for local oscillation in a direct conversion receiver including a down converter, which mixes a received signal and a signal having a frequency equal to a frequency of the received signal so as to convert the received signal into a baseband signal, the method comprising the steps of:
outputting a local oscillation signal of a predetermined frequency;
converting the local oscillation signal into a fractional harmonic signal having a frequency equal to a frequency of the received signal; and
outputting the fractional harmonic signal to the down converter.

9. The method as claimed in claim 8, wherein the fractional harmonic signal conversion step comprises:
generating a medium frequency signal by dividing the previously generated fractional harmonic signal by a predetermined integer; and
generating the fractional harmonic signal by mixing the local oscillation signal and the medium frequency signal

10. The method as claimed in claim 9, wherein the fractional harmonic signal conversion step further comprises band-pass-filtering the fractional harmonic signal.

11. The method as claimed in claim 9, wherein the fractional harmonic signal conversion step further comprises amplifying the fractional harmonic signal.

12. The method as claimed in claim 9, wherein the fractional harmonic signal conversion step further comprises:
band-pass-filtering the fractional harmonic signal; and
amplifying the band-pass-filtered signal.

13. A direct conversion receiver including a down converter, which mixes a received signal and a signal having a frequency equal to a frequency of the received signal so as to convert the received signal into a baseband signal, the direct conversion receiver comprising:
a local oscillator for outputting a local oscillation signal of a predetermined frequency; and
a fractional signal generator for converting the local oscillation signal into a fractional harmonic signal of a frequency equal to a frequency of the received signal, and outputting the converted fractional harmonic signal to the down converter, the fractional signal generator comprising:
a divider for dividing a frequency of an output signal of the fractional signal generator by a predetermined integer;
a mixer for mixing the local oscillation signal and an output signal of the divider;
a band pass filter for filtering an output signal of the mixer; and
an amplifier for amplifying a signal filtered through the band pass filter.

14. The direct conversion receiver as claimed in claim 13, wherein the band pass filter filters a “+” or “−” harmonic component from the output signal of the mixer.
